(19) United States
(12) Patent Application Publication
(10) Pub. No.: US 2025/0209639 A1
(43) Pub. Date: Jun. 26, 2025

(54) OBJECT TRACKING METHOD, AND TERMINAL DEVICE AND COMPUTER-READABLE STORAGE MEDIUM USING THE SAME

(71) Applicant: UBTECH ROBOTICS CORP LTD, Shenzhen (CN)

(72) Inventors: SHUPING HU, Shenzhen (CN); Kan Wang, Shenzhen (CN); Pei Dong, Shenzhen (CN); Jianxian Pang, Shenzhen (CN); Huan Tan, Shenzhen (CN)

(21) Appl. No.: 18/969,295

(22) Filed: Dec. 5, 2024

(30) Foreign Application Priority Data
Dec. 22, 2023 (CN) 202311788072.2

(51) Int. Cl. G06T 7/246

(52) U.S. Cl. CPC G06T 7/248; G06T 2207/10016; G06T 2207/20081

(57) ABSTRACT

An object tracking method, and a terminal device and a computer-readable storage medium using the same are provided. The method includes: obtaining a first filtered image by filtering out the moving object in the i-th image frame, where the moving object is an object in the i-th image frame that has a positional change relative to the object in the (i−1)-th image frame, and i is an integer larger than 1; determining, based on the first filtered image, a pixel mapping relationship between the (i−1)-th image frame and the i-th image frame; and tracking, according to the pixel mapping relationship, the moving object. Through the above-mentioned method, the reliability of the trajectory matching results can be improved, thereby improving the reliability of object tracking.

### CROSS REFERENCE TO RELATED APPLICATIONS

The present disclosure claims priority to Chinese Patent Application No. 202311788072.2, filed Dec. 22, 2023, which is hereby incorporated by reference herein as if set forth in its entirety.

### TECHNICAL FIELD

The present disclosure relates to image processing technology, and particularly to an object tracking method, and a terminal device and a computer-readable storage medium using the same.

### BACKGROUND

Object tracking is one of the important directions of research in the field of computer vision, which has the goals to detect, extract, identify and track objects of interest (i.e., target objects) in continuous images, so as to obtain relevant parameters of target objects like position, speed, scale, and trajectory for further processing and analyzing, thereby achieving the understanding of the behaviors of the target objects or performing higher-level tasks.

The object tracking algorithm involves the trajectory matching of the target object in two adjacent image frames. In some application scenarios, the shooting process of images is often accompanied by the shaking or movement of the camera itself, which will reduce the reliability of the trajectory matching results, thereby reducing the reliability of object tracking.

### BRIEF DESCRIPTION OF DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a schematic diagram of object tracking according to an embodiment of the present disclosure.

FIG. 2 is a flow chart of an object tracking method according to an embodiment of the present disclosure.

FIG. 3 is a flow chart of a filtering method according to an embodiment of the present disclosure.

FIG. 4 is a schematic diagram of the structure of an object tracking apparatus according to an embodiment of the present disclosure.

FIG. 5 is a schematic diagram of the structure of a terminal device according to an embodiment of the present disclosure.

### DETAILED DESCRIPTION

In the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

It is to be understood that, when used in the description and the appended claims of the present disclosure, the terms “including” and “comprising” indicate the presence of stated features, integers, steps, operations, elements and/or components, but do not preclude the presence or addition of one or a plurality of other features, integers, steps, operations, elements, components and/or combinations thereof.

It is also to be understood that the term “and/or” used in the description and the appended claims of the present disclosure refers to any combination of one or more of the associated listed items and all possible combinations, and includes such combinations.

As used in the description and the appended claims, the term “if” may be interpreted as “when” or “once” or “in response to determining” or “in response to detecting” according to the context. Similarly, the phrase “if determined” or “if [the described condition or event] is detected” may be interpreted as “once determining” or “in response to determining” or “on detection of [the described condition or event]” or “in response to detecting [the described condition or event]”.

In addition, in the specification and the claims of the present disclosure, the terms “first”, “second”, “third”, and the like in the descriptions are only used for distinguishing, and cannot be understood as indicating or implying relative importance.

References such as “one embodiment” and “some embodiments” in the specification of the present disclosure mean that the particular features, structures or characteristics described in combination with the embodiment(s) are included in one or more embodiments of the present disclosure. Therefore, the sentences “in one embodiment,” “in some embodiments,” “in other embodiments,” “in still other embodiments,” and the like in different places of this specification are not necessarily all refer to the same embodiment, but mean “one or more but not all embodiments” unless specifically emphasized otherwise.

Object tracking is one of the important directions of research in the field of computer vision, which has the goals to detect, extract, identify and track objects of interest (i.e., target objects) in continuous images, so as to obtain relevant parameters of target objects like position, speed, scale, and trajectory for further processing and analyzing, thereby achieving the understanding of the behaviors of the target objects or performing higher-level tasks.

The object tracking algorithm involves the trajectory matching of the target object in two adjacent image frames. In some application scenarios, the shooting process of images is often accompanied by the shaking or movement of the camera itself, which will reduce the reliability of the trajectory matching results, thereby reducing the reliability of object tracking.

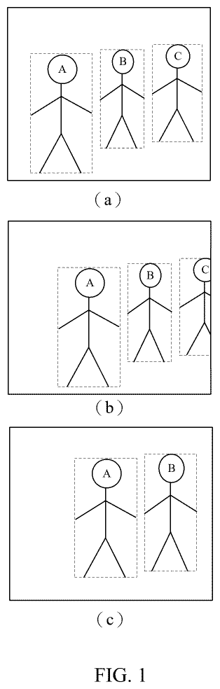

FIG. 1 is a schematic diagram of object tracking according to an embodiment of the present disclosure. As shown in part (a) of FIG. 1 that shows a certain image frame of target object A, target object B and target object C, during object tracking, if target objects A, B and C move while a camera capturing the mage frame does not move, the next image frame of the image frame shown in part (a) of FIG. 1 will be as shown in part (b) of FIG. 1. Since the movements are continuous, if the current frame is used for correlation search or the related movement information is used for matching, there is a high probability that there will be no error. During object tracking, if the camera is shaken or moved due to the movement of its carrying platform while the target objects A, B and C move, the next image frame of the image frame shown in part (a) of FIG. 1 is as shown in part (c) of FIG. 1. It can be seen that the positions of the target objects in the figure have shifted significantly. In this case, errors may occur if the current frame is used for correlation search or the motion information is used for matching, for example, the trajectory of target object A may be coupled to target object B, and the trajectory of target object B may be coupled to target object C.

Based on this, the embodiments of the present disclosure provide a object tracking method. In this embodiment, by filtering out objects that may move in the image, the previous and the next image frames meet the condition that the background remains unchanged, and an image transformation matrix caused by the movement of the camera can be obtained. Then, an object tracking is performed based on the detection frame corresponding to the object tracking category in the transformed the previous and next image frames, which can effectively reduce the impact of the movement of the camera on the tracking result so as to improve the reliability of object tracking.

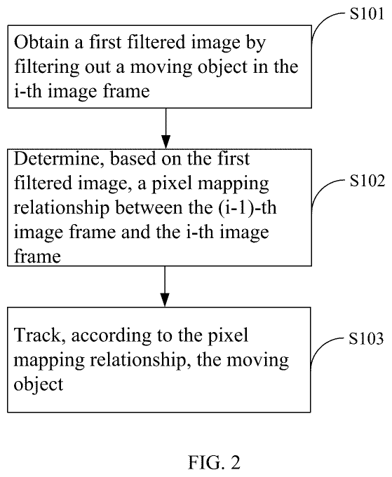

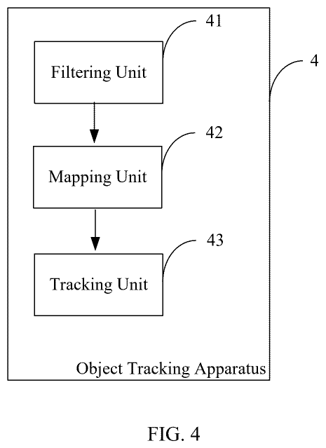

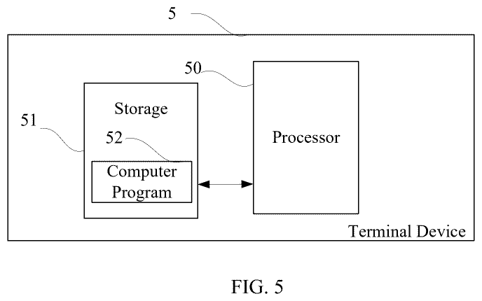

FIG. 2 is a flow chart of an object tracking method according to an embodiment of the present disclosure. In this embodiment, a method for tracking moving objects may be applied on (a processor of) an apparatus for tracking moving objects shown in FIG. 4. In other embodiments, the method may be implemented through a terminal device shown in FIG. 5. As shown in FIG. 2, as an example, in this embodiment, the object tracking method may include the following steps.

S101: obtaining a first filtered image by filtering out a moving object in the i-th image frame.

In which, i is an integer larger than 1. The image frames are a sequence of images captured through a camera (of, for example, the apparatus for tracking objects of FIG. 4 or the terminal device of FIG. 5),

In some embodiments, among image frames, for the 1-st image frame may be ignored; for the 2-nd image frame, object tracking may be performed based on the 1-st image frame and the 2-nd image frame; for the third image frame, object tracking may be performed based on the 2-nd image frame and the 3-rd image frame; and so on.

It should be noted that in the process of tracking the moving object based on the i−2-th image frame and the (i−1)-th image frame, the filtering method of the (i−1)-th image frame that filters out the moving object is the same as that of the i-th image frame.

In this embodiment, the moving object (e.g., target object A, B, or C in FIG. 1) is an object in the i-th image frame that has a positional change relative to the object in the (i−1)-th image frame. For example, in the (i−1)-th image frame including a background and a person, if the position of the person in the i-th image frame changes, the moving object is the person.

S102: determining, based on the first filtered image, a pixel mapping relationship between the (i−1)-th image frame and the i-th image frame.

S103: tracking, according to the pixel mapping relationship, the moving object.

Since a part of the image of the moving object has been filtered out from the filtered i-th image frame and (i−1)-th image frame, which is equivalent to retain another part of the image of the background and non-moving objects in the filtered i-th image frame and (i−1)-th image frame, the impact of the moving object on the object tracking results can be effectively reduced by performing object tracking based on the part of the image of the background and the non-moving objects in two adjacent image frames (e.g., the (i−1)-th image frame and the i-th image frame), thereby improving the reliability of object tracking.

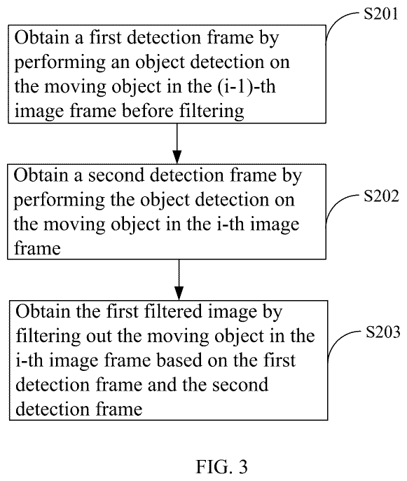

FIG. 3 is a flow chart of a filtering method according to an embodiment of the present disclosure. In some embodiments, as shown in FIG. 3, as an example, step S101 may include the following steps.

S201: obtaining a first detection frame by performing an object detection on the moving object in the (i−1)-th image frame before filtering.

In this embodiment, the moving object in the (i−1)-th image frame may be detected through an image detection algorithm or an image detection model. As an example, step S201 may include:

obtaining a trained detection model for detecting the moving objects in an image; and obtaining the first detection frame by inputting the (i−1)-th image frame into the detection model.

In which, the detection model may output the first detection frame and an object type of the moving object.

In this embodiment, the detection model may be trained in advance.

Specifically, a large number of sample images including moving objects and type labels corresponding to the moving objects may be collected first. In order to ensure the accuracy of the detection model, a sample set may include sample images of different moving objects. Then, the detection model may be trained using the sample images until a detection accuracy of the detection model reaches a preset accuracy. Eventually, the detection model that reaches the preset accuracy may be used as the trained detection model.

In which, the moving object may be a person, an animal, a vehicle, or other movable objects. It should be noted that in some extended schemes, in order to avoid a certain type of object from affecting the detection result, the object of that type may also be used as the moving object.

In this embodiment, the detection model may adopt a neural network model or other algorithm model that can realize functions for object detection.

S202: obtaining a second detection frame by performing the object detection on the moving object in the i-th image frame.

The specific implementation of step S202 is similar to that of step S201. For details, please refer to the description of S201, which will not be repeated herein.

S203: obtaining the first filtered image by filtering out the moving object in the i-th image frame based on the first detection frame and the second detection frame.

In steps S201-S203, by filtering based on the result of the object detection on two adjacent image frames, the impact of the detection error of individual frame on the filtering can be effectively reduced, thereby improving the effectiveness of the filtering result.

In some embodiments, step S203 may include: determining whether the object type corresponding to the first detection frame is the same as that corresponding to the second detection frame; obtaining the first filtered image by deleting an image in the second detection frame in response to the object type corresponding to the first detection frame being the same as that corresponding to the second detection frame; and performing no processing in response to the object type corresponding to the first detection frame being not the same as that corresponding to the second detection frame.

Although the forgoing processing is relatively simple, it is equivalent to filtering out all the images in the detection frame. When the detection frame area in the image accounts for a large proportion, more image information will be lost, which is not conducive to subsequent detection.

To improve the above-mentioned defect, in other embodiments, step S203 may include:

S301: obtaining first feature groups.

In which, each of the first feature groups includes a first feature point and a second feature point. The first feature point is one feature point obtained by performing a feature extraction processing on the (i−1)-th image frame, and the second feature point is another feature point obtained by performing the feature extraction processing on the i-th image frame.

In some embodiments, step S301 may include:
I, obtaining the first feature points and first descriptors corresponding to the first feature pointes, by performing the feature extraction processing on the (i−1)-th image frame;
II, obtaining the second feature points obtained by performing the feature extraction processing on the i-th image frame and a second descriptor corresponding to each of the second feature points; and
III, obtaining the first feature groups by matching each of the first feature points and each of the second feature points based on the corresponding first descriptor and the corresponding second descriptor.

In which, the obtained feature point may include pixel coordinates of the feature point. The descriptor may be feature information of the feature point like a feature vector or a feature value.

In this embodiment, matching using the descriptor is equivalent to matching using the feature information of the feature point, which can effectively improve the accuracy of matching.

In some embodiments, in step I and step II, the feature points of the (i−1)-th image frame and the i-th image frame and the descriptors corresponding to the feature points may be obtained using a trained feature extraction model, that is, the feature extraction processing may be performed through the trained feature extraction model.

In an example, the above-mentioned detection model may include a feature extraction module and a detection module. That is, the image may be input into the detection model to extract features of the image by the feature extraction module in the detection model first, then the features may be input into the detection module in the detection model to output the detection frame and the object type. Correspondingly, in this example, it may draw an “interface” from the output end of the feature extraction module. After the (i−1)-th image frame is input into the detection model, the “interface” outputs the features of the (i−1)-th image frame (i.e., the first feature point and the first descriptor corresponding to the first feature point); and after the i-th image frame is input into the detection model, the “interface” outputs the features of the i-th image frame (i.e., the second feature point and the second descriptor corresponding to the second feature point).

In another example, the feature extraction model may be connected before the detection model, that is, the detection model and the feature extraction model may be two independent models. In this example, the detection model and the feature extraction model may be trained simultaneously. For example, it may input the sample image into the feature extraction model first to output the feature information of the sample image, and the feature information of the sample image may be input into the detection model to output a detection result; then a loss value may be calculated according to the detection result; if the loss value is less than or equal to a preset value, the current detection model may be taken as the trained detection model, otherwise if the loss value is larger than the preset value, model parameters of the detection model and the feature extraction model may be adjusted simultaneously to obtain the adjusted detection model and feature extraction model; then the sample image may be input into the adjusted feature extraction model to continue training until the calculated loss value is less than or equal to the preset value.

In some embodiment, step III may include:
calculating a feature distance between the first descriptor of each of the first feature points and the second descriptor of each of the second feature points;
generating a third feature group with the second feature point and the first feature point corresponding to the minimum feature distance among the calculated feature distances; and
taking the third feature group as the first feature group, in response to the feature distance corresponding to the third feature group being larger than a preset threshold.

In which, the feature distance between the first descriptor and the second descriptor may be an Euclidean distance, a Jaccard distance or a Mahalanobis distance between the first descriptor and the second descriptor. For example, when the Jaccard distance is used, it may calculate based on an equation of

$$sim = \frac{{\sum }_{i} min ( {x}_{i} , {y}_{i} )}{{\sum }_{i} max ( {x}_{i} , {y}_{i} )}$$

where xi represents the i-th element in the first descriptor, and y represents the i-th element in the second descriptor.

It should be noted that the feature distance represents the degree of difference between the first feature point and the second feature point. The smaller the feature distance, the smaller the difference between the first feature point and the second feature point, that is, the more similar the two are.

In this embodiment, after obtaining the matching first feature point and second feature point, the matching feature points with too large feature distance may be filtered out, thereby filtering out the feature points with matching errors or large matching errors. In this manner, the influence of some feature points with obvious differences on subsequent detection can be reduced, which is conducive to improving the detection accuracy.

In other embodiments, for any first feature point, a similarity between the first descriptor of the first feature point and the second descriptor of each of the second feature points may be calculated; the third feature group with the second feature point corresponding to the maximum calculated similarity and the first feature point may be generated; if the similarity corresponding to the third feature group is less than or equal to a preset similarity, the third feature group may be taken as the first feature group.

In which, the similarity between the first descriptor and the second descriptor may be a cosine similarity between the first descriptor and the second descriptor. For example, it may be calculated based on an equation of

$$s i m = \frac{X \cdot Y}{\vert X \vert \vert Y \vert} ,$$

where X represents the first descriptor and Y represents the second descriptor.

It should be noted that the similarity represents the degree of similarity between the first feature point and the second feature point. The greater the similarity, the greater the degree of similarity between the first feature point and the second feature point, that is, the more similar the two are.

In this embodiment, by matching using the feature points, the partial areas in the two adjacent image frames that represent the same object can be obtained accurately, providing a reliable data basis for subsequent detection.

S302: taking each of the first feature groups as the second feature group, in response to the first feature point in the first feature group being not within the first detection frame and the second feature point in the first feature group being not within the second detection frame, where the first filtered image is composed of the second feature points in the second feature group.

In some embodiments, whether the feature point (e.g., the first feature point) is within the detection frame (e.g., the first detection frame) may be determined based on the coordinates of the feature point and that of the vertexes of the detection frame. For example, it may determine the minimum horizontal coordinate, the maximum horizontal coordinate, the minimum vertical coordinate, and the maximum vertical coordinate based on the coordinates of the vertexes of the detection frame; then determine whether the horizontal coordinate of the feature point is larger than the minimum horizontal coordinate, less than the maximum horizontal coordinate, larger than the minimum vertical coordinate, and less than the maximum vertical coordinate; if yes, it may determine that the feature point is within the detection frame; otherwise, it may determine that the feature point is not within the detection frame.

It should be noted that the determination of the boundary point may be defined in advance according to the actual situation. For example, if the horizontal coordinate of the feature point is equal to that of a certain vertex of the detection frame, it may determine that the feature point is within the detection frame or without within the detection frame.

In this embodiment, the first filtered image is composed of the second feature point in the second feature groups.

In steps S301-S302, it is equivalent to filtering out only the feature points in the detection frame and some image information can be retained, which is conducive to subsequent detection.

In some embodiments, step S102 may include: constructing a linear equation; selecting any two second feature groups; and determining parameters of the linear equation by substituting the coordinates of each of the first feature point and the second feature point in the selected two second feature groups into the linear equation. The calculated linear equation is a transformation matrix.

In practical applications, due to the transformation matrix between two adjacent image frames is not necessarily a linear relationship, by adopting the forgoing method, it may not represent the transformation relationship between the two adjacent image frames accurately.

In some embodiments, step S102 may include:

constructing an overdetermined system based on the second feature group corresponding to the first filtered image; and calculating a transformation matrix by solving the overdetermined system.

In which, the transformation matrix is for representing a pixel mapping relationship between the (i−1)-th image frame and the i-th image frame.

In which, the second feature group corresponding to the first filtered image represents that the second feature point in the second feature group belongs to the first filtered image.

In which, the overdetermined system refers to equations in which the number of constraint equations is larger than that of parameters. It may construct a constraint equation for each second feature group. Since the number of the constraint equations is larger than that of the parameters, the overdetermined system may be solved using the least squares algorithm so as to obtain the optimal solution by fitting. The optimal solution is the parameters of the transformation matrix.

In other words, the overdetermined system is a problem of fitting, which is to fit an optimal result based on the constraint relationship provided by more input data. Since there are more input data, if there is a large error in certain data, the constraint relationship provided by other data may be used to correct it so as to have a high fault tolerance rate, and the distribution of the input data can be more diverse so that there has better stability.

S401: obtaining a first transformed image by transforming the i-th image frame based on the transformation matrix

S402: obtaining a third detection frame by transforming the second detection frame based on the transformation matrix.

In this embodiment, the first transformed image may be transformed by calculating based on an equation of I′=H·I, and the third detection frame may be calculated based on an equation of d′=H·d. In which, I represents the coordinates of the pixel point in the i-th image frame, I′ represents the coordinates of the pixel point in the first transformed image, d represents the coordinates of the vertexes of the second detection frame, d′ represents the coordinates of the vertexes of the third detection frame, and H represents the transformation matrix.

S403: tracking the moving object based on the first transformed image and the third detection frame.

In this embodiment, the method for subsequent object tracking is not specifically limited.

In this embodiment, by filtering out objects that may move in the image, the previous and the next image frames meet the condition that the background remains unchanged, and an image transformation matrix caused by the movement of the camera can be obtained. Then, an object tracking is performed based on the detection frame corresponding to the object tracking category in the transformed the previous and next image frames, which can effectively reduce the impact of the movement of the camera on the tracking result so as to improve the reliability of object tracking. It should be understood that, the sequence of the serial number of the steps in the above-mentioned embodiments does not mean the execution order while the execution order of each process should be determined by its function and internal logic, which should not be taken as any limitation to the implementation process of the embodiments.

FIG. 4 is a schematic diagram of the structure of an object tracking apparatus according to an embodiment of the present disclosure. An object tracking apparatus 4 corresponding to the object tracking method described in the above-mentioned embodiment that is for tracking a moving object in a sequence of image frames is provided. For the convenience of explanation, only the part related to this embodiment is shown.

As shown in FIG. 4, the object tracking apparatus 4 may include:
a filtering unit 41 configured to obtain a first filtered image by filtering out the moving object in the i-th image frame, wherein the moving object is an object in the i-th image frame that has a positional change relative to the object in the (i−1)-th image frame, and i is an integer larger than 1;
a mapping unit 42 configured to determine, based on the first filtered image, a pixel mapping relationship between the (i−1)-th image frame and the i-th image frame; and
a tracking unit 43 configured to track, according to the pixel mapping relationship, the moving object.

In some embodiments, the filtering unit 41 may be further configured to:
obtain a first detection frame by performing an object detection on the moving object in the (i−1)-th image frame;
obtain a second detection frame by performing the object detection on the moving object in the i-th image frame; and
obtain the first filtered image by filtering out the moving object in the i-th image frame based on the first detection frame and the second detection frame.

In some embodiments, the filtering unit 41 may be further configured to:
obtain first feature groups each including a first feature point and a second feature point, wherein the first feature point is one feature point obtained by performing a feature extraction processing on the (i−1)-th image frame, and the second feature point is one feature point obtained by performing the feature extraction processing on the i-th image frame; and
take each of the first feature groups as the second feature group, in response to the first feature point in the first feature group being not within the first detection frame and the second feature point in the first feature group being not within the second detection frame, wherein the first filtered image is composed of the second feature points in the second feature group.

In some embodiments, the filtering unit 41 may be further configured to:
obtain the first feature points and first descriptors corresponding to the first feature pointes, by performing the feature extraction processing on the (i−1)-th image frame;
obtain the second feature points obtained by performing the feature extraction processing on the i-th image frame and a second descriptor corresponding to each of the second feature points; and
obtain the first feature groups by matching each of the first feature points and each of the second feature points based on the corresponding first descriptor and the corresponding second descriptor.

In some embodiments, the filtering unit 41 may be further configured to:
calculate a feature distance between the first descriptor of each of the first feature points and the second descriptor of each of the second feature points;
generate a third feature group with the second feature point and the first feature point corresponding to the minimum feature distance among the calculated feature distances; and
take the third feature group as the first feature group, in response to the feature distance corresponding to the third feature group being larger than a preset threshold.

In some embodiments, the mapping unit 42 may be further configured to:
construct an overdetermined system based on the second feature group corresponding to the first filtered image; and
calculate a transformation matrix by solving the overdetermined system, wherein the transformation matrix is for representing the pixel mapping relationship between the (i−1)-th image frame and the i-th image frame.

In some embodiments, the tracking unit 43 may be further configured to:
obtain a first transformed image by performing a transformation processing on the i-th image frame based on the transformation matrix;
obtain a third detection frame by performing the transformation processing on the second detection frame based on the transformation matrix; and
track the moving object based on the first transformed image and the third detection frame.

In some embodiments, the tracking unit 43 may be further configured to construct an overdetermined system based on the second feature group corresponding to the first filtered image; and calculating a transformation matrix by solving the overdetermined system.

In some embodiments, the filtering unit 41 may be further configured to:
obtain a trained detection model for detecting the moving objects in an image; and
obtain the first detection frame by inputting the (i−1)-th image frame into the detection model.

It should be noted that the information interaction, execution process and other contents between the above-mentioned apparatus/units are based on the same concept as the method embodiment of the present disclosure, and their specific functions and technical effects can be specifically referred to the method embodiment part, which will not be described herein.

In addition, the object tracking apparatus 4 shown in FIG. 4 may be a software unit, a hardware unit, or a unit combining software and hardware that is built into an existing terminal device, or it may be integrated into the terminal device as an independent plug-in; otherwise, it may exist as an independent terminal device.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

FIG. 5 is a schematic diagram of the structure of a terminal device 5 according to an embodiment of the present disclosure. As shown in FIG. 5, in this embodiment, the terminal device 5 (e.g., a vehicle or a robot) may include at least one processor 50 (only one is shown in FIG. 5), a storage 51, and a computer program 52 stored in the storage 51 and can be executed on the at least one processor 50. In addition, the terminal device 5 may further include a camera for capturing a sequence of image frames. When the processor 50 executes the computer program 52, the steps in each of the above-mentioned embodiments of the object tracking method are implemented.

The terminal device 5 may be a computing device such as a desktop computer, a notebook computer, a tablet computer, and a cloud server. The terminal device 5 may include, but is not limited to, the processor 50 and the storage 51. It can be understood by those skilled in the art that FIG. 5 is merely an example of the terminal device 5 and does not constitute a limitation on the terminal device 5, and may include more or fewer components than those shown in the figure, or a combination of some components or different components. For example, the terminal device 5 it may further include an input/output device, a network access device, and the like.

The processor 50 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 51 may be an internal storage unit of the terminal device 5, for example, a hard drive or a memory of the terminal device 5. In other embodiments, the storage 51 may also be an external storage device of the terminal device 5, for example, a plug-in hard drive, a smart media card (SMC), a secure digital (SD) card, or a flash card that is equipped on the terminal device 5. Furthermore, the storage 51 may also include both the internal storage units and the external storage devices of the terminal device 5. The storage 51 may be configured to store operating systems, applications, boot loaders, data, and other programs such as codes of computer programs. The storage 51 may also be configured to temporarily store data that has been output or will be output.

The present disclosure further provides a computer-readable storage medium. The computer-readable storage medium is stored with a computer program. When the computer program is executed by a processor, the steps in each of the above-mentioned method embodiments can be implemented.

The present disclosure further provides a computer program product. When the computer program product is executed on the terminal device, the terminal device can implement the steps in the above-mentioned method embodiments.

When the integrated unit is implemented in the form of a software functional unit and is sold or used as an independent product, the integrated unit may be stored in a non-transitory computer-readable storage medium. Based on this understanding, all or part of the processes in the method for implementing the above-mentioned embodiments of the present disclosure are implemented, and may be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include at least any entity or device, a recording medium, a computer memory, a read-only memory (ROM), a random access memory (RAM), electric carrier signals, telecommunication signals and software distribution media that is capable of carrying the computer program codes on an apparatus/the terminal device, for example, a USB flash drive, a portable hard disk, a magnetic disk, an optical disk, or the like. In some jurisdictions, according to the legislation and patent practice, a computer readable medium cannot be electric carrier signals and telecommunication signals.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative modules and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device), terminal device and method may be implemented in other manners. For example, the above-mentioned apparatus/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The modules described as separate components may or may not be physically separated. The components represented as modules may or may not be physical modules, that is, may be located in one place or be distributed to multiple network modules. Some or all of the modules may be selected according to actual needs to achieve the objectives of this embodiment.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

1. A method for tracking a moving object in a sequence of image frames, comprising:
obtaining a first filtered image by filtering out the moving object in the i-th image frame among the sequence of image frames, wherein the moving object is an object in the i-th image frame that has a positional change relative to the object in the (i−1)-th image frame among the sequence of image frames, and i is an integer larger than 1;
determining, based on the first filtered image, a pixel mapping relationship between the (i−1)-th image frame and the i-th image frame; and
tracking, according to the pixel mapping relationship, the moving object.

2. The method of claim 1, obtaining the first filtered image by filtering out the moving object in the i-th image frame comprises:
obtaining a first detection frame by performing an object detection on the moving object in the (i−1)-th image frame;
obtaining a second detection frame by performing the object detection on the moving object in the i-th image frame; and
obtaining the first filtered image by filtering out the moving object in the i-th image frame based on the first detection frame and the second detection frame.

3. The method of claim 2, obtaining the first filtered image by filtering out the moving object in the i-th image frame based on the first detection frame and the second detection frame comprises:
obtaining first feature groups each including a first feature point and a second feature point, wherein the first feature point is one feature point obtained by performing a feature extraction processing on the (i−1)-th image frame, and the second feature point is one feature point obtained by performing the feature extraction processing on the i-th image frame; and
taking each of the first feature groups as the second feature group, in response to the first feature point in the first feature group being not within the first detection frame and the second feature point in the first feature group being not within the second detection frame, wherein the first filtered image is composed of the second feature points in the second feature group.

4. The method of claim 3, obtaining the first feature groups comprises:
obtaining the first feature points and first descriptors corresponding to the first feature pointes, by performing the feature extraction processing on the (i−1)-th image frame;
obtaining the second feature points obtained by performing the feature extraction processing on the i-th image frame and a second descriptor corresponding to each of the second feature points; and
obtaining the first feature groups by matching each of the first feature points and each of the second feature points based on the corresponding first descriptor and the corresponding second descriptor.

5. The method of claim 4, obtaining the first feature groups by matching each of the first feature points and each of the second feature points based on the corresponding first descriptor and the corresponding second descriptor comprises:
calculating a feature distance between the first descriptor of each of the first feature points and the second descriptor of each of the second feature points;
generating a third feature group with the second feature point and the first feature point corresponding to the minimum feature distance among the calculated feature distances; and
taking the third feature group as the first feature group, in response to the feature distance corresponding to the third feature group being larger than a preset threshold.

6. The method of claim 3, determining, based on the first filtered image, the pixel mapping relationship between the (i−1)-th image frame and the i-th image frame comprises:
constructing an overdetermined system based on the second feature group corresponding to the first filtered image; and
calculating a transformation matrix by solving the overdetermined system, wherein the transformation matrix is for representing the pixel mapping relationship between the (i−1)-th image frame and the i-th image frame.

7. The method of claim 6, tracking, according to the pixel mapping relationship, the moving object comprises:
obtaining a first transformed image by transforming the i-th image frame based on the transformation matrix;
obtaining a third detection frame by transforming the second detection frame based on the transformation matrix; and
tracking the moving object based on the first transformed image and the third detection frame.

8. The method of claim 2, obtaining the first detection frame by performing the object detection on the moving object in the (i−1)-th image frame comprises:
obtaining a trained detection model for detecting the moving objects in an image; and
obtaining the first detection frame by inputting the (i−1)-th image frame into the detection model.

9. A terminal device, comprising:
a camera capturing a sequence of image frames;
a processor;
a memory coupled to the processor; and
one or more computer programs stored in the memory and executable on the processor;
wherein, the one or more computer programs comprise:
instructions for obtaining a first filtered image by filtering out a moving object in the i-th image frame among the sequence of image frames captured through the camera, wherein the moving object is an object in the i-th image frame that has a positional change relative to the object in the (i−1)-th image frame among the sequence of image frames captured through the camera, and i is an integer larger than 1;
instructions for determining, based on the first filtered image, a pixel mapping relationship between the (i−1)-th image frame and the i-th image frame; and
instructions for tracking, according to the pixel mapping relationship, the moving object.

10. The terminal device of claim 9, the instructions for obtaining the first filtered image by filtering out the moving object in the i-th image frame comprise:
instructions for obtaining a first detection frame by performing an object detection on the moving object in the (i−1)-th image frame;
instructions for obtaining a second detection frame by performing the object detection on the moving object in the i-th image frame; and
instructions for obtaining the first filtered image by filtering out the moving object in the i-th image frame based on the first detection frame and the second detection frame.

11. The terminal device of claim 10, the instructions for obtaining the first filtered image by filtering out the moving object in the i-th image frame based on the first detection frame and the second detection frame comprise:
instructions for obtaining first feature groups each including a first feature point and a second feature point, wherein the first feature point is one feature point obtained by performing a feature extraction processing on the (i−1)-th image frame, and the second feature point is one feature point obtained by performing the feature extraction processing on the i-th image frame; and
instructions for taking each of the first feature groups as the second feature group, in response to the first feature point in the first feature group being not within the first detection frame and the second feature point in the first feature group being not within the second detection frame, wherein the first filtered image is composed of the second feature points in the second feature group.

12. The terminal device of claim 11, the instructions for obtaining the first feature groups comprise:
instructions for obtaining the first feature points and first descriptors corresponding to the first feature pointes, by performing the feature extraction processing on the (i−1)-th image frame;
instructions for obtaining the second feature points obtained by performing the feature extraction processing on the i-th image frame and a second descriptor corresponding to each of the second feature points; and
instructions for obtaining the first feature groups by matching each of the first feature points and each of the second feature points based on the corresponding first descriptor and the corresponding second descriptor.

13. The terminal device of claim 12, the instructions for obtaining the first feature groups by matching each of the first feature points and each of the second feature points based on the corresponding first descriptor and the corresponding second descriptor comprise:
instructions for calculating a feature distance between the first descriptor of each of the first feature points and the second descriptor of each of the second feature points;
instructions for generating a third feature group with the second feature point and the first feature point corresponding to the minimum feature distance among the calculated feature distances; and
instructions for taking the third feature group as the first feature group, in response to the feature distance corresponding to the third feature group being larger than a preset threshold.

14. The terminal device of claim 11, the instructions for determining, based on the first filtered image, the pixel mapping relationship between the (i−1)-th image frame and the i-th image frame comprise:
instructions for constructing an overdetermined system based on the second feature group corresponding to the first filtered image; and
instructions for calculating a transformation matrix by solving the overdetermined system, wherein the transformation matrix is for representing the pixel mapping relationship between the (i−1)-th image frame and the i-th image frame.

15. The terminal device of claim 14, the instructions for tracking, according to the pixel mapping relationship, the moving object comprise:
instructions for obtaining a first transformed image by transforming the i-th image frame based on the transformation matrix;
instructions for obtaining a third detection frame by transforming the second detection frame based on the transformation matrix; and
instructions for tracking the moving object based on the first transformed image and the third detection frame.

16. The terminal device of claim 10, the instructions for obtaining the first detection frame by performing the object detection on the moving object in the (i−1)-th image frame comprise:
instructions for obtaining a trained detection model for detecting the moving objects in an image; and
instructions for obtaining the first detection frame by inputting the (i−1)-th image frame into the detection model.

15. (canceled)

16. (canceled)

17. (canceled)

18. (canceled)

19. (canceled)

20. (canceled)

21. A non-transitory computer-readable storage medium for storing one or more computer programs, wherein the one or more computer programs comprise:
instructions for obtaining a first filtered image by filtering out a moving object in the i-th image frame among the sequence of image frames, wherein the moving object is an object in the i-th image frame that has a positional change relative to the object in the (i−1)-th image frame among the sequence of image frames, and i is an integer larger than 1;
instructions for determining, based on the first filtered image, a pixel mapping relationship between the (i−1)-th image frame and the i-th image frame; and
instructions for tracking, according to the pixel mapping relationship, the moving object.

22. The storage medium of claim 21, the instructions for obtaining the first filtered image by filtering out the moving object in the i-th image frame comprise:
instructions for obtaining a first detection frame by performing an object detection on the moving object in the (i−1)-th image frame;
instructions for obtaining a second detection frame by performing the object detection on the moving object in the i-th image frame; and
instructions for obtaining the first filtered image by filtering out the moving object in the i-th image frame based on the first detection frame and the second detection frame.

23. The storage medium of claim 22, the instructions for obtaining the first filtered image by filtering out the moving object in the i-th image frame based on the first detection frame and the second detection frame comprise:
instructions for obtaining first feature groups each including a first feature point and a second feature point, wherein the first feature point is one feature point obtained by performing a feature extraction processing on the (i−1)-th image frame, and the second feature point is one feature point obtained by performing the feature extraction processing on the i-th image frame; and
instructions for taking each of the first feature groups as the second feature group, in response to the first feature point in the first feature group being not within the first detection frame and the second feature point in the first feature group being not within the second detection frame, wherein the first filtered image is composed of the second feature points in the second feature group.

24. The storage medium of claim 23, the instructions for obtaining the first feature groups comprise:
instructions for obtaining the first feature points and first descriptors corresponding to the first feature pointes, by performing the feature extraction processing on the (i−1)-th image frame;
instructions for obtaining the second feature points obtained by performing the feature extraction processing on the i-th image frame and a second descriptor corresponding to each of the second feature points; and
instructions for obtaining the first feature groups by matching each of the first feature points and each of the second feature points based on the corresponding first descriptor and the corresponding second descriptor.
